(19) United States
(12) Patent Application Publication
(10) Pub. No.: US 2020/0342647 A1
(43) Pub. Date: Oct. 29, 2020

(54) CHARACTER CREATION METHOD AND APPARATUS, STORAGE DEVICE, AND ELECTRONIC DEVICE

(71) Applicant: Yiyang XU, Guangzhou (CN)

(72) Inventor: Yiyang XU, Guangzhou (CN)

(73) Assignee: Yiyang Xu, Guangzhou (CN)

(21) Appl. No.: 16/393,072

(22) Filed: Apr. 24, 2019

(51) Int. Cl. G06T 13/40; G06T 17/10; G06T 15/00; G06F 16/58; G06F 16/535

(52) U.S. Cl. CPC G06T 13/40; G06T 17/10; G06F 16/535; G06F 16/5866; G06T 15/005

(57) ABSTRACT

The present disclosure discloses a caricature creation method and apparatus, a storage device, and an electronic device, wherein the method includes the following steps of: acquiring an identifier of a caricature-to-be-created and a current display direction of the caricature-to-be-created; searching for caricature attribute information based on the identifier of the caricature-to-be-created; searching for current constituent parts of the caricature-to-be-created based on the caricature attribute information and the current display direction; combining the current constituent parts to form a target caricature; and rendering the target caricature and using the rendered target c caricature as the created caricature.

### TECHNICAL FIELD

The present disclosure relates to the field of software, and in particular to a caricature creation method and apparatus, a storage device, and an electronic device.

### BACKGROUND ART

With the improvement of economic level and the gradual enrichment of cultural life of people, comics have gradually penetrated into the lives of young people. People can browse all kinds of comics by various means such as by comic books and network. The comic is an art form and is a drawing depicting life or current affairs in a simple and exaggerated manner. In general, a humorous and amusing picture or group of pictures are formed by using methods such as transformation, metaphor, exaggeration, simile, symbolism, suggestion, and insinuation to provoke people to think while bringing entertainment to people. In the prior art, users are no longer satisfied with passively browsing comics, and more and more people hope to be able to actively participate in the creation of various comics. However, the comic creation process in the prior art is cumbersome and inconvenient, and the creators are required to be relatively high professional. Therefore, the prior art has yet to be improved and developed.

### SUMMARY

In view of the above deficiencies of the prior art, some embodiments of the present disclosure can provide a caricature creation method and apparatus, a storage device, and an electronic device.

In some embodiments, the technical solutions of the present disclosure are as follows:

A caricature creation method, wherein the method is executable by an electronic device, the method comprising following steps of:

acquiring an identifier of a caricature-to-be-created and a current display direction of the caricature-to-be-created;

searching for caricature attribute information based on the identifier of the caricature-to-be-created;

searching for current constituent parts of the caricature-to-be-created based on the caricature attribute information and the current display direction;

combining the current constituent parts to form a target caricature; and rendering the target caricature and using the rendered target caricature as the created caricature.

A caricature creation apparatus, the apparatus being provided on an electronic device, the apparatus comprising:

an acquisition module configured to acquire an identifier of a caricature-to-be-created and a current display direction of the caricature-to-be-created;

an attribute searching module configured to search for caricature attribute information based on the identifier of the caricature-to-be-created;

a part searching module configured to search for current constituent parts of the caricature-to-be-created based on the caricature attribute information and the current display direction;

a first combination module configured to combine the current constituent parts to form a target caricature; and

a first rendering module configured to render the target caricature and use the rendered target caricature as the created caricature.

A storage device, in which a plurality of instructions are stored, wherein the instructions are adapted to be loaded and executed by a processor to:

acquire an identifier of a caricature-to-be-created and a current display direction of the caricature-to-be-created; search for caricature attribute information based on the identifier of the caricature-to-be-created; search for current constituent parts of the caricature-to-be-created based on the caricature attribute information and the current display direction: combine the current constituent parts to form a target caricature; and render the target caricature and use the rendered target caricature as the created caricature.

An electronic device, comprising:

a processor adapted to implement each instruction; and

a storage device adapted to store a plurality of instructions, wherein the instructions are adapted to be loaded and executed by the processor to:

acquire an identifier of a caricature-to-be-created and a current display direction of the caricature-to-be-created; search for caricature attribute information based on the identifier of the caricature-to-be-created; find current constituent parts of the caricature-to-be-created based on the caricature attribute information and the current display direction; combine the current constituent parts to form a target caricature; and render the target caricature and use the rendered target caricature as the created caricature.

In order to enable the above objects, features, and advantages of the present disclosure to be more apparent and easily understandable, preferred embodiments will be described below in detail by way of example and with reference to the accompanying drawings.

### BRIEF DESCRIPTION OF DRAWINGS

FIG. 1 is a flowchart of a caricature creation method of the present disclosure.

FIG. 2 is a schematic diagram showing a relation between a caricature and components in the present disclosure.

FIG. 3 is a logic diagram of turning of a caricature of the present disclosure.

FIG. 4 is a logic diagram of displaying a human caricature in the present disclosure.

FIG. 5 is a structural diagram of a direction component in the present disclosure.

FIG. 6 is a logic diagram of one-click turning in the present disclosure.

FIG. 7 is a schematic diagram of a caricature object in a right front direction in the present disclosure.

FIG. 8 is a schematic diagram of a caricature object in a forward (front) direction in the present disclosure.

FIG. 9 is a schematic diagram of a caricature object in a right rear direction in the present disclosure.

FIG. 10 is a schematic structural diagram of a square grid draft paper in the present disclosure.

FIG. 11 is a schematic diagram of a face shape in a front view drawn on a grid draft paper in the present disclosure.

FIG. 12 is a schematic diagram of a face shape in a 45-degree side view drawn on a grid draft paper in the present disclosure.

FIG. 13 is a schematic diagram of a face shape in a 90-degree side view drawn on a grid draft paper in the present disclosure.

FIG. 14 is a schematic diagram of a face shape in an oblique back view drawn on a grid draft paper in the present disclosure.

FIG. 15 is a schematic diagram of a face shape in a back view drawn on a grid draft paper in the present disclosure.

FIG. 16 is a schematic diagram showing hierarchical splitting of a caricature in the present disclosure.

FIG. 17 is a schematic diagram showing a change in expression of a caricature in the present disclosure.

FIG. 18 is a schematic diagram showing a change in hairstyle of a caricature in the present disclosure.

FIG. 19 is a schematic diagram showing a change in clothing of a caricature in the present disclosure.

FIG. 20 is a schematic diagram showing a change in movement and direction of a caricature in the present disclosure.

FIG. 21 is a structural block diagram of a caricature creation apparatus in the present disclosure.

FIG. 22 is a schematic structural diagram of an electronic device in the present disclosure.

### DETAILED DESCRIPTION OF EMBODIMENTS

The present disclosure provides a caricature creation method and apparatus, a storage device, and an electronic device. In order to make the objects, technical solutions, and effects of the present disclosure more definite and explicit, the present disclosure will be described in further detail below. It should be understood that specific embodiments described herein are merely intended to illustrate the present disclosure and are not intended to limit the present disclosure.

The present disclosure provides a caricature creation executable by an electronic device, wherein the electronic device may be a user client, and the method comprises the following steps S102 to S110:

S102, acquiring an identifier of a caricature-to-be-created and a current display direction of the caricature-to-be-created (i.e., a direction in which the caricature-to-be-created is to be currently displayed).

The identifier of the caricature-to-be-created may be a caricature ID selected by a user. In a specific implementation, the client may receive the caricature ID inputted by the user and the current display direction of the caricature-to-be-created selected by the user. It can be understood that the caricature-to-be-created is usually a stereoscopic image, which may be a person or may be an animal or the like, and different effects are produced when the caricature-to-be-created is displayed in different directions. For example, a display effect when the face of the caricature-to-be-created faces forward is completely different from a display effect when the face of the caricature-to-be-created faces backward. The current display direction of the caricature-to-be-created may be set by the user as required.

S104, searching for caricature attribute information based on the identifier of the caricature-to-be-created.

In a specific implementation, the caricature attribute information corresponding to the identifier of the caricature-to-be-created may be searched in a first server (also referred to as an application server). Here, the caricature attribute information may include more than one of address(es) where the parts of the caricature are located (which may also be understood as a file address of caricature part information), the name of the caricature, the gender of the caricature, or a thumbnail of the caricature.

S106, searching for current constituent parts of the caricature-to-be-created based on the caricature attribute information and the current display direction.

In a specific implementation, constituent parts of the caricature-to-be-created corresponding to the current display direction may be searched in a second server (also referred to as a material server) based on the address(es) where the parts of the caricature are located; and the found constituent parts are used as the current constituent parts of the caricature-to-be-created. It can be understood that different display directions are corresponding to different constituent parts, for example, the face parts corresponding to the caricature facing forward (front side) are different from the face parts corresponding to the caricature facing backward (back side). Here, constituent parts corresponding to the caricature displayed in different directions are stored on the second server.

S108, combining the current constituent parts to form a target caricature. Since the user may download constituent parts from the second server in advance when the caricature is created using the client previously, the downloaded constituent parts may exist in a location such as a cache area of the client without being downloaded repeatedly, therefore it may be first judged whether the found current constituent parts are stored in a specified storage area; wherein if not, the current constituent parts in the second server are downloaded to a specified storage area, and the current constituent parts in the specified storage area are combined to form a target caricature. If yes, the constituent parts in the specified storage area are combined directly to form the target caricature.

When the current constituent parts in the specified storage area are to be combined to form a target caricature, part attribute information of each of the current constituent parts may be acquired; and then the current constituent parts are combined based on the part attribute information to form the target caricature. The part attribute information may include part size, part location, part layer, and so on. Different constituent parts may be hierarchically combined based on their layers. During combination, an order for combining different constituent parts may be set based on preset part layers.

S110, rendering the target caricature, and the rendered target caricature is used as the created caricature. In the present disclosure, matching between various material components, for example, the matching of hair, facial expressions, face shapes, movements, etc., can be achieved so as to further enrich the image of the caricature and enhance the personalization of an animation caricature. Moreover, since all the materials are stored on the material server, the user can implement the selection/replacement of combination of material components of the animation caricature on any terminal, which is very convenient in use.

Further, the present disclosure also provides a caricature turning (i.e., direction-changing) mode, which may be specifically performed with reference to the following steps:

(1) Acquiring constituent parts corresponding to a new display direction of the caricature-to-be-created is acquired based on the identifier and the current display direction of the caricature-to-be-created when a turning instruction is received.

In a specific implementation, all the constituent parts corresponding to the caricature-to-be-created may be searched in the first server based on the identifier of the caricature-to-be-created; a next display direction of the caricature-to-be-created is determined based on the current display direction of the caricature-to-be-created and a predetermined turning order (ordering of turning); and searching for constituent parts corresponding to the next display direction.

(2) Combining the acquired constituent parts to form a target caricature in the new display direction.

(3) Rendering the target caricature in the new display direction is rendered. The process of the present disclosure will be described in detail below.

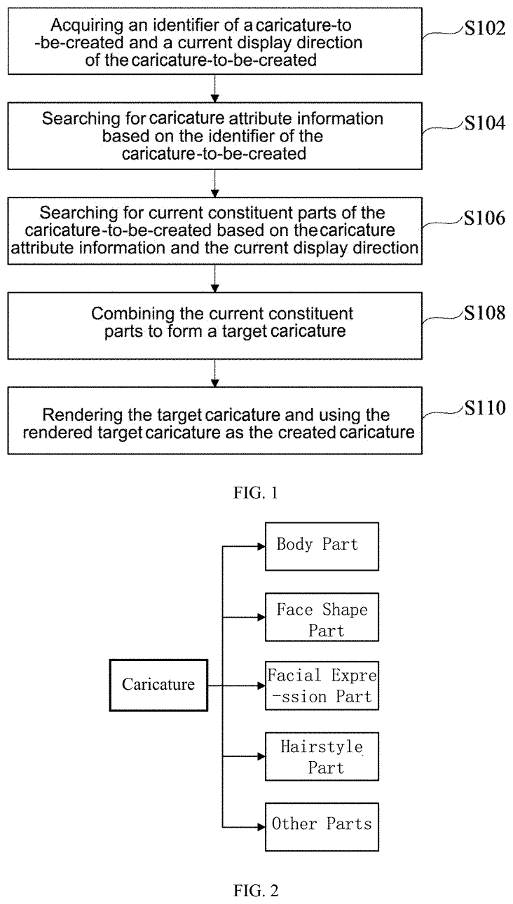

Generally speaking, one caricature (which may be an image such as a person or an animal or the like) is composed of constituent parts such as a body, a face shape, a facial expression, and a hairstyle. In other words, as shown in FIG. 2, the material components include a body part, a face shape part, a facial expression part, and a hairstyle part, that is, one caricature comprises the above-mentioned parts, and may also comprise other parts evidently. The parts in the present embodiment may also be referred to as components.

The various constituent parts are combined according to predetermined hierarchical relations therebetween, in other words, each material part is provided with at least one layer set in advance. It can be understood that for the same display direction, different parts are provided with different layers; and for the same part, the corresponding layers may be different in different display directions. For ease of understanding, an exemplary description is made as follows: a hairstyle is divided into a portion in front of the head and a portion behind the head. When combined into a target caricature, the portion in front of the head is located at a front layer of the head, and the portion behind the head is located at a back layer of the head. A facial expression is divided into a portion in front of the head and a portion behind the head. When combined into a target caricature, the portion in front of the head is located at the front layer of the head, and the portion behind the head is located at the back layer of the head.

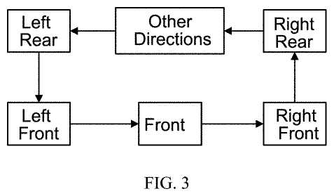

The direction of the caricature, in some embodiments, may be divided into front, right front, right rear, left front, left rear and other directions, and different display effects are exhibited in different display directions. As shown in FIG. 3, the turning logic (the predetermined turning order) is in the order from the front, the right front, the right rear, the left rear, the left front, to the front. That is, assuming that the current display direction is the front, then the next display direction will be the right front. Of course, in practical applications, other turning orders, such as from the front, the left front, the left rear, the right rear, the right front, to the front, may also be set as required.

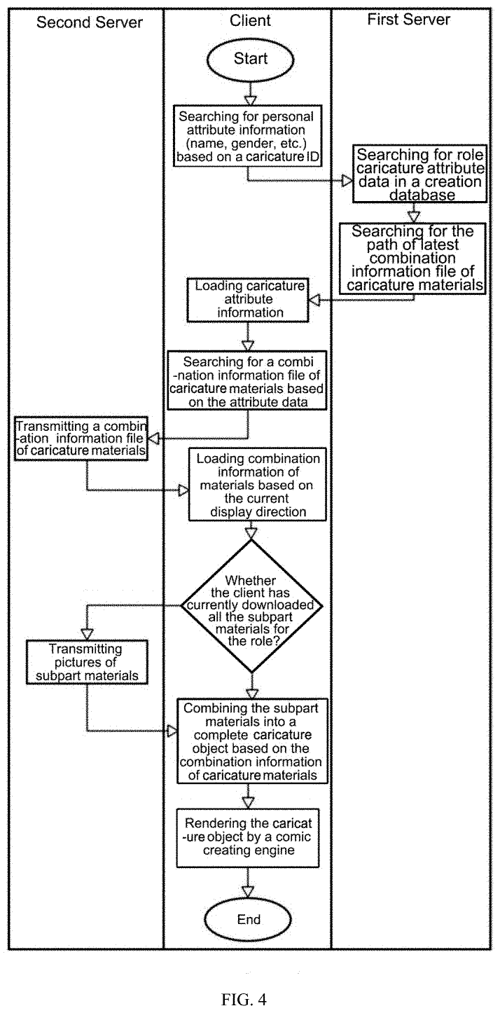

A logic diagram of display of a human caricature in the present disclosure is shown in FIG. 4 as a whole. The details are as follows:

Step 1, firstly searching the first server for role attribute data in based on the caricature ID selected by the user, and loading caricature attribute information based on the found role attribute data.

Before that, the user may firstly determine a caricature ID on the client and search the first server for role attribute data, for example the name and gender of the caricature and so on. At the same time, the first server may be searched for the latest path of combination information file of caricature materials (the aforementioned address(es) where the parts of the caricature are located), so that it is convenient to search the second server for a combination information file of caricature material (i.e., a file containing caricature parts) in. Caricature attribute information is loaded based on the found role attribute data. The caricature attribute information is a subset of the role attribute data, the role attribute data is a relatively broad concept containing a variety of attribute data such as the name and gender of a caricature, a caricature ID, and an ID of a user to which the caricature belongs, and the caricature attribute information may be an attribute in the role attribute data that is attributed to and required for the caricature-to-be-created.

Step 2, searching the second server for a combination information file of caricature materials based on the found role attribute data.

Since the path of the combination information file of caricature materials is also acquired in the previous step, the combination information file of caricature materials can be quickly acquired from the second server with convenience at this time.

Step 3, loading combination information of caricature materials based on the found combination information file of caricature materials and the current display direction.

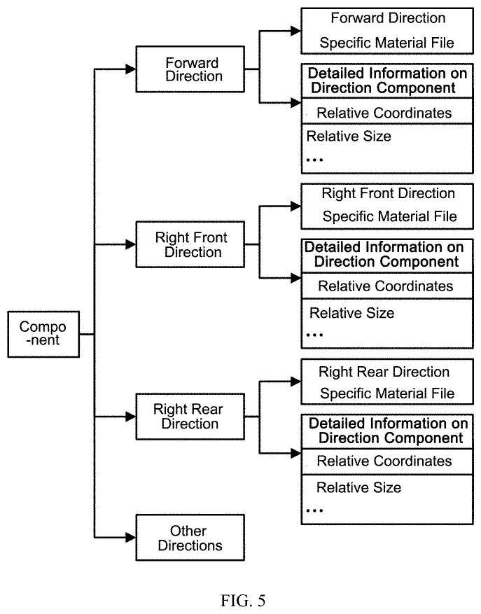

Specifically, the structure of direction parts is as shown in FIG. 5. Taking a case where the current display direction is the front as an example for description, in step 3, a specific material file oriented to the “forward direction” may be loaded, and the specific material file contains detailed information on the direction components, such as the combination information of caricature materials like relative coordinates and relative size of each component, the layer of each component and so on, and may also contain information about how the components of the caricature are matched, for example information such as the specific forms and layers of components such as body movements, facial expressions, hair, and clothing.

Further, the above-mentioned method further comprises:

judging whether the client has currently downloaded all the material components corresponding to the caricature ID;

wherein if not, acquiring all the material components from the material server and then combining all the material components, and if yes, directly combining the material components.

In the above-mentioned steps, it is judged, based on the combination information of caricature materials, whether the client has downloaded all the material components (also referred to as constituent parts or parts) of the caricature, for example a hairstyle component, a face shape component, a facial expression component, a clothing component, and so on. If the material components are not downloaded or incomplete, all the material components may be downloaded from the material server, and then the subsequent step 4 is performed, and if the client has downloaded all the material components of the caricature, the process proceeds directly to step 4.

Step 4, combining the material components into a complete caricature object based on the composition information of caricature materials.

For example, the hairstyle component, the face shape component, the facial expression component, and the clothing component in the current display direction are combined into a complete caricature object in a predetermined order of layers.

Step 5, rendering the caricature object.

Specifically, a comic creating engine may be used to render the caricature object to obtain a complete animation caricature.

Further, the above-mentioned method further comprises:

Step 6, invoking, when a turning instruction is received, a turning interface based on the caricature ID and the current display direction, combining a new caricature object, and loading combination information of caricature materials in a new direction.

In the present disclosure, an image obtained after selection/replacement of combination of material components of an animation caricature can be not only completely exhibited, but also can be turned so as to obtain a more enriched and more stereoscopic animation image to result in a more well-rounded role.

Further, the step 6 comprises:

S61, searching the first server for a combination information file of caricature materials based on the caricature ID and acquiring all component IDs; and determining a next display direction by a predetermined turning logic; and searching for next display information of each component ID based on the next display direction; and combining, based on the next display information of each component ID, a turned caricature object (whose turning is completed). Evidently, it is also possible to directly acquire all component information corresponding to the next display direction, and in this mode, each display direction is associated with and corresponding to all the information of components in the direction, and it is unnecessary to search for the next display information of each component ID one by one; and in practical applications, the above-mentioned mode may be flexibly implemented as required, which is not limited here; S62, the client receiving the turned caricature object and the corresponding material components from the first server;

S63, combining the material components and the turned caricature object; and

S64, rendering the turned caricature object.

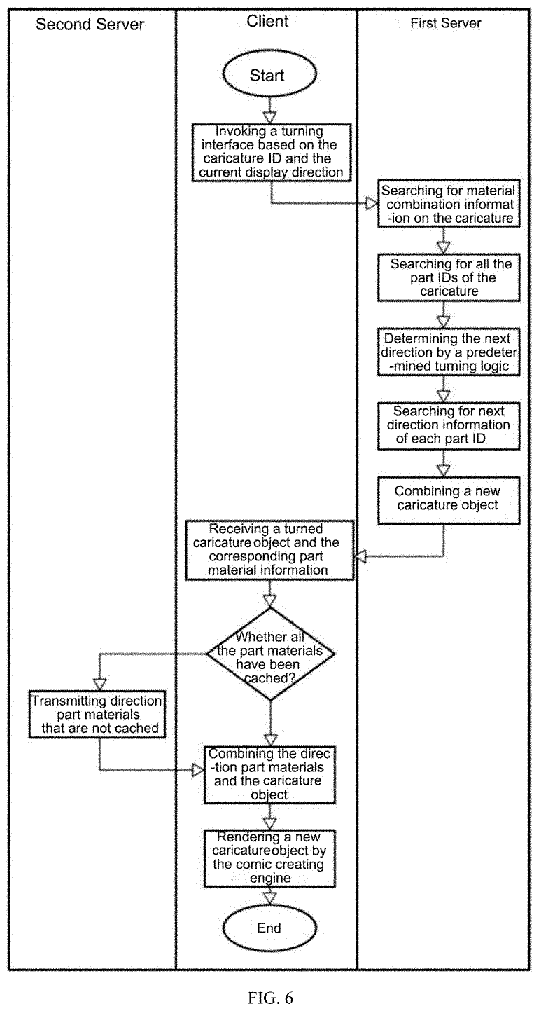

The one-click turning logic in the present disclosure is as shown in FIG. 6. Specifically, in the step S61, the corresponding combination information file of caricature materials is searched based on the caricature ID, and all component IDs are found. Specifically, for example, the component IDs are XX01, XX02, XX03, and XX04, wherein XX01 represents a hairstyle component, XX02 represents a face shape component, XX03 represents a facial expression component, and XX04 represents a clothing component.

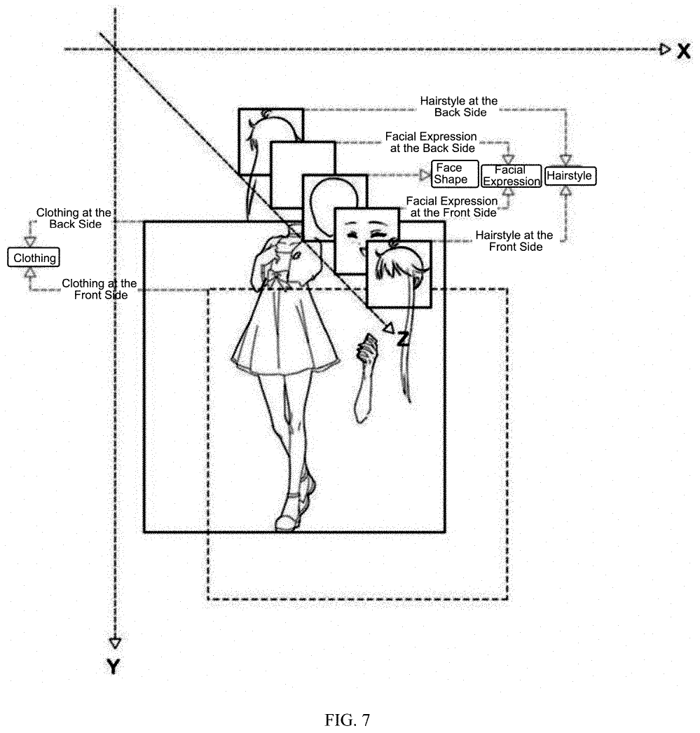

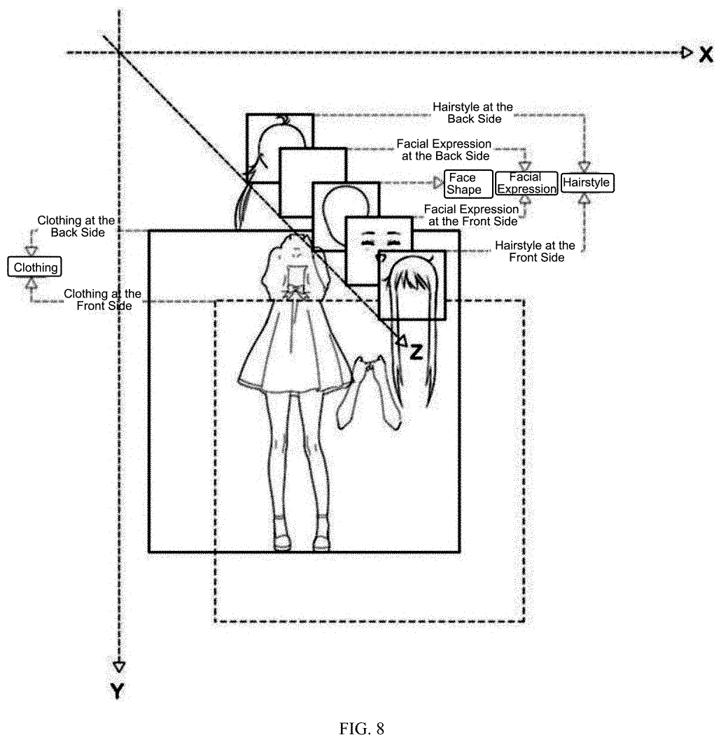

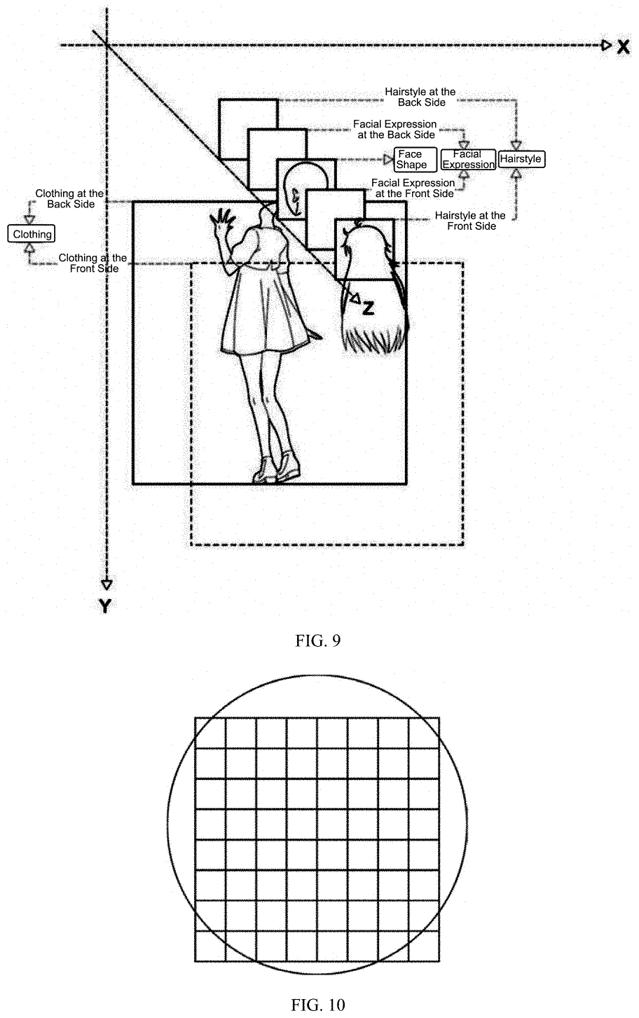

Determining the next display direction based on the current display direction means determining the next display direction based on the preset turning logic. For example, if the current display direction is the right front, then the next display direction is the right rear. The rest may be deduced by analogy. FIG. 7 is a schematic diagram of a caricature object in a right front direction in the present disclosure. FIG. 8 is a schematic diagram of a caricature object in a forward (front) direction in the present disclosure. FIG. 9 is a schematic diagram of a caricature object in a right rear direction in the present disclosure. The caricature object is displayed with different content in different display directions. As shown in FIG. 7 to FIG. 9, the caricature object is displayed with different effects in different directions, mainly in that constituent parts are different and the layer of each individual constituent part is changed.

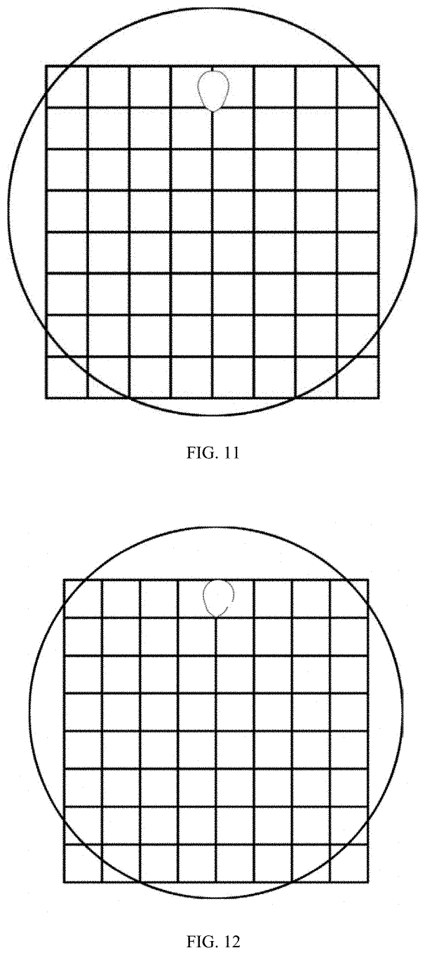

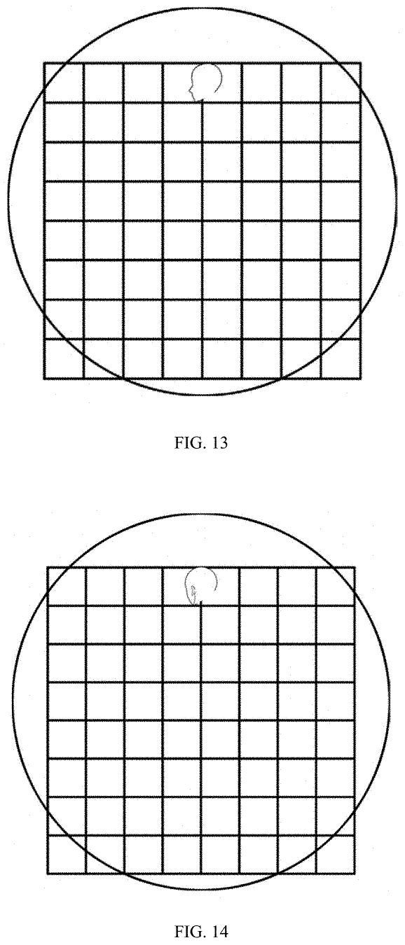

When a caricature is to be displayed, as shown in FIG. 10, a grid draft paper having a head-height ratio of 1:1 to 1:11 is firstly prepared, and then the position of the head is determined, and head models in 8 or more directions such as left and right side, left and right front, left and right rear, the rear, and the front directions are drawn after the positioning, as shown in FIG. 11 to FIG. 15. In addition to the multi-angle, the head may also have a variety of body features, which may include facial features such as oval face, square face, double chin, baby face, and chubby face, and head coordinates (taking a piece of canvas with 512*512 pixels as an example, a pixel at the top left corner of the head picture is taken as a measurement reference point): and then the proportion of the human body is determined based on different display directions and features such as the gender and movement of the caricature with the head as a fixed point. Generally speaking, the caricature has a head-height ratio ranging from 1:4 to 1:12 depending on differences in age, gender, clothing, movement, etc. Then, contents such as the facial expression, hair, clothing, and movement of the caricature are drawn based on the determined head, movements of the body and the current display direction. That is to say, after the coordinates of head are fixed, all the newly added elements such as clothing, hair, and facial expression are based on the head coordinates and attached to the head. Moreover, in order to adapt to the clothing matching in the actual operating environment, the various parts such as hair, clothing, and movement are split by layers. For example, the face shape of the head is at Layer 0, several layers are newly added upwards (i.e., 1, 2, etc.) or downwards (i.e., −1, −2) on the basis of the Layer 0 according to the caricature's requirements, and for example, the hair is divided into two layers in front of (Layer 2) and behind (Layer −2) the head, the layers of the body is divided into two portions which are −1 and 3, and the facial expression is at Layer 1. The finally formed caricature is a replaceable series having multiple orientations, layers and movements and having a wide variety of proportions of head-height ratios.

The coordinates of head (taking a piece of canvas with 512*512 pixels as an example, a pixel at the top left corner of the head picture is taken as a measurement reference point), a specific example is shown in Table 1 below:

| | Size of Head | | Coordinates of Head | |
|---|---|---|---|---|
| | Picture | | Picture | |
| | W | H | X | Y |
| Coordinates | (Width) | (Height) | (Horizontal) | (Vertical) |
| Front View | 45 | 60 | 234 | 74 |
| Oblique Side View | 49 | 60 | 236 | 75 |
| Oblique Back View | 51 | 61 | 231 | 74 |
| 90-degree Side View | 51 | 60 | 235 | 75 |
| Back View | 45 | 60 | 235 | 82 |

Here, the above-mentioned Table 1 is described by taking a piece of canvas of 512*512 as an example. If the length and width of the canvas are multiplied by 2, it is magnified to 1024*1024; and in order that all the values in Table 1 are maintained at a same ratio, all of the values need to be synchronously multiplied by 2.

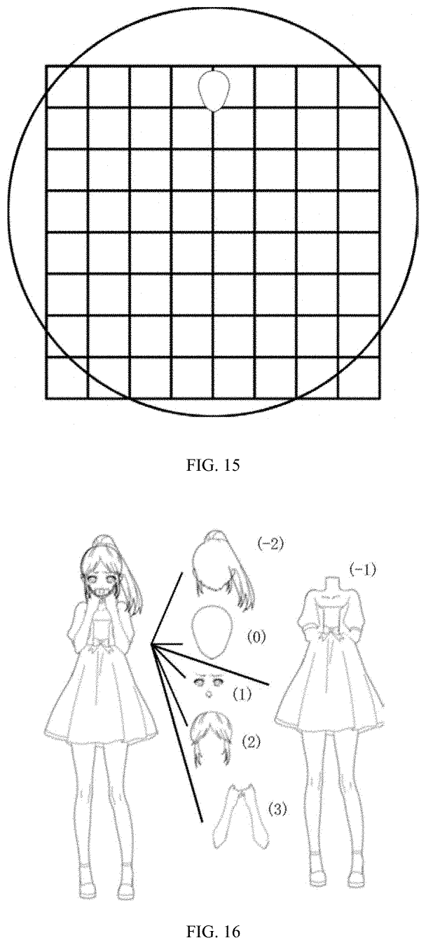

Layer 1: as shown in FIG. 16, based on the layer of the head, the head is at Layer 0, and a layer is newly established upward from the layer of the head as Layer 1 for drawing a facial expression (of five sense organs) including multiple expressions commonly used for caricatures such as joy, anger, sadness, happiness, crying, etc. In addition, it is also necessary to draw multiple facial orientations such as left and right side, left and right front, left and right rear, and the front directions to show a variety of emotions and orientations of the caricature. The positions of the five sense organs on the head are fixed in accordance with a range of the reference lines, wherein the five sense organs of the front face are invisible in oblique back and back views.

Layer 2: A layer is newly established upward from Layer 1 as Layer 2 for drawing the hair in front of the caricature's forehead for use in the front and side views, and for drawing the hair at the back in the case of the back view of the caricature.

Layer 3: A layer is newly established upward from Layer 2 as Layer 3 for drawing a portion of the body parts that passes, overlaps, or covers the face, hair, or the like. For example, if both hands of a certain caricature are closely attached to the face, the hands should be located at an upward layer relative to the whole head, but the body is located at a next layer relative to the head, thus the hands should be cut out and placed at the Layer 3 to avoid a visual error.

Layer −1: A layer is newly established downward from the Head Layer 0 as Layer −1 for drawing the main torso of the body.

Layer −2: A layer is newly established downward from Layer −1 as Layer −2 for drawing the hair placed at the back for use in the front and side views, and for drawing the hair in front of the forehead in the case of the back view of the caricature.

Layer −3: A layer is newly established downward from Layer −2 as Layer −3 for drawing some props or items that can be placed on the back, such as wings, an umbrella, a backpack, etc.

In the present disclosure, the materials are split by using the drawing method into clothing (body), hairstyle (hair at the front and at the back), facial expression, and face shape, and each portion has 5 to 8 orientations drawn previously, and can be purchased by the user in the material section. During the actual use, the user can replace the individual components of a specific caricature. Since the head is used as fixed coordinates in drawing, and moreover the coordinates are anchored during the development process, the individual components and directions of the caricature can be naturally fused.

As shown in FIG. 17, the facial expression of the caricature in the present disclosure can be changed with freedom in, and each facial expression is drawn in 8 or more orientations for being optionally selected by the user. For example, in FIG. 17, there are three facial expressions, wherein taking the second facial expression as an example, 8 orientations are possible, which sequentially indicate a rear view, a left rear view, a left front view, a 45-degree left side view, a front view, a 45-degree right side view, a right side view, and a right rear view.

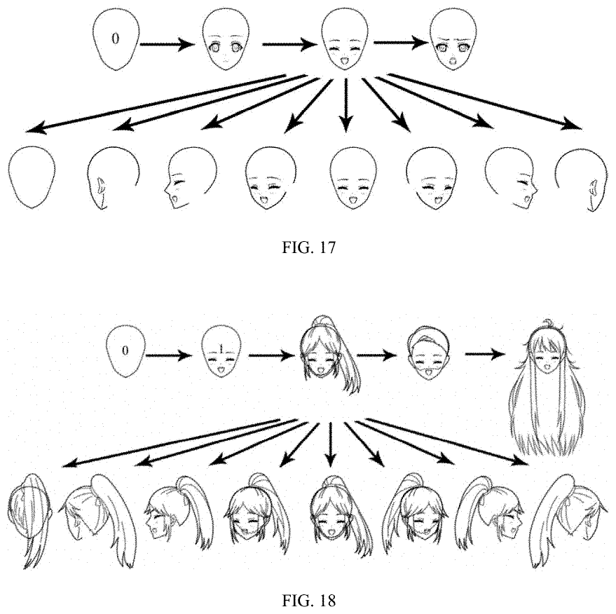

As shown in FIG. 18, the hairstyle of the caricature in the present disclosure can be changed with freedom, and each hairstyle is drawn in 8 or more orientations for being optionally selected by the user. For example, in FIG. 18, three hairstyles are provided, wherein taking the first hairstyle among them as an example, 8 orientations are available, which sequentially indicate a rear view, a left rear view, a left front view, a 45-degree left side view, a front view, a 45-degree right side view, a right side view, and a right rear view.

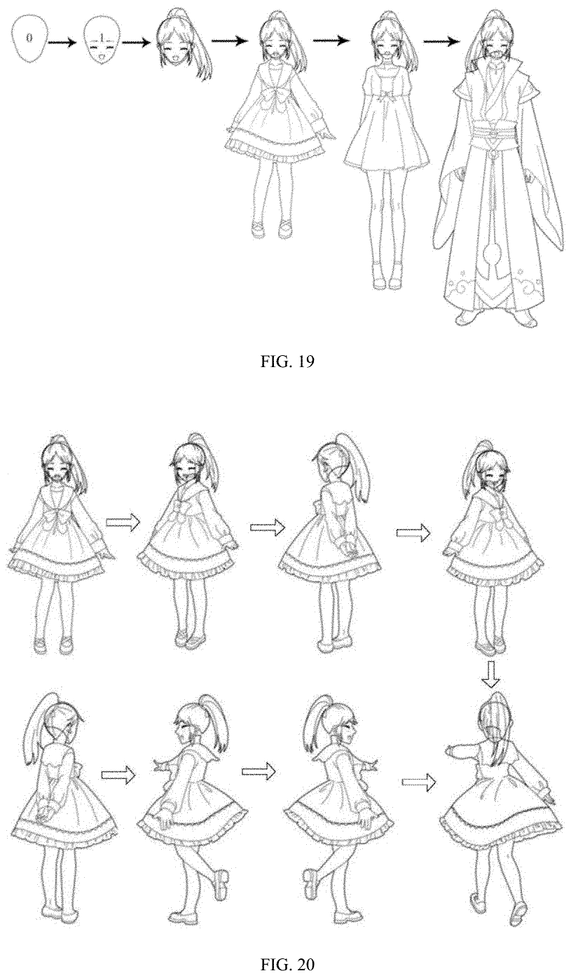

As shown in FIG. 19, the clothing, body type, gender, and the like of the caricature in the present disclosure can also be changed with freedom. Taking FIG. 19 as an example, three different clothes are displayed after the facial expression and hairstyle are added.

As shown in FIG. 20, the movement, direction, and the like of the caricature in the present disclosure can be changed with freedom. Evidently, the illustrated arrows are only exemplary, and the specific implementation may be carried out in accordance with other turning logic, for example, in accordance with the turning logic shown in FIG. 3.

The reason for searching for the next display information of each component ID based on the next display direction is that different component IDs is provided with different display contents in each display direction. For example, the hairstyle component is displayed as a certain content in the “front” display direction, and then displayed as another content in the “right front” display direction.

The combining the turned caricature object based on the next display information of each component ID indicates that the turned caricature object is composed of the components it contains.

In the step S62, the client receives the turned caricature object and the corresponding material components from the application server. That is, the action of the step S61 is completed in the first server, and the first server returns the caricature object and the material components to the client after the completion.

In the step S63, the material components and turned the caricature object are combined; that is, the contents of XX01, XX02, XX03, and XX04 which are to be displayed in the next display direction are combined. It should be noted that the combination should be performed here according to different layers in each component. For example, if a certain component contains two different layers of contents, then the two layers to be displayed should be different from each other.

In the step S64, the turned caricature object is rendered. Specifically, the caricature object may be rendered by using a comic creating engine.

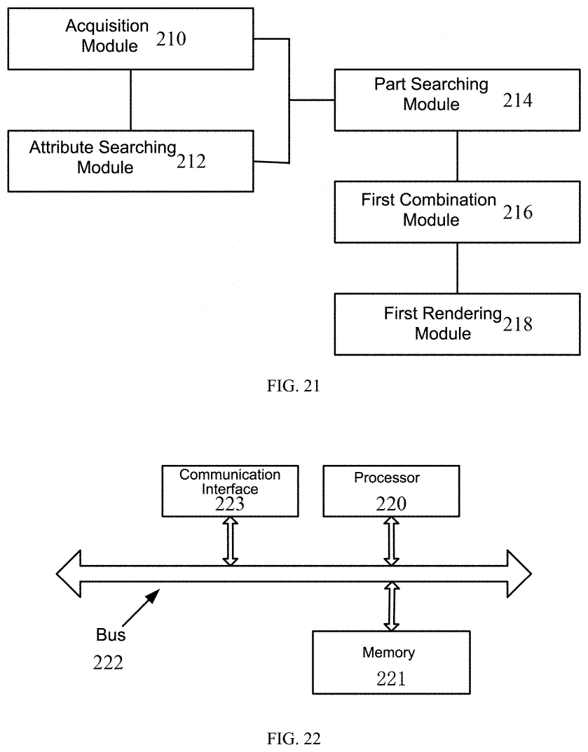

The present disclosure also provides a caricature creation apparatus, which is provided on an electronic device. Referring to a structural block diagram of a caricature creation apparatus shown in FIG. 21, the apparatus comprises:

an acquisition module 210 configured to acquire an identifier of a caricature-to-be-created and a current display direction of the caricature-to-be-created;

an attribute searching module 212 configured to search for caricature attribute information based on the identifier of the caricature-to-be-created;

a part searching module 214 configured to search for current constituent parts of the caricature-to-be-created based on the caricature attribute information and the current display direction;

a first combination module 216 configured to combine the current constituent parts to form a target caricature; and

a first rendering module 218 configured to render the target caricature and use the rendered target caricature as the created caricature.

In some embodiments, the attribute searching module is configured to: search a first server for the caricature attribute information corresponding to the identifier of the caricature-to-be-created; wherein the caricature attribute information includes more than one of an address(es) where the parts of the caricature are located, the name of the caricature, the gender of the caricature, and a thumbnail of the caricature.

In some embodiments, the caricature attribute information includes an address(es) where the parts of the caricature are located, and the part searching module is configured to: search a second server for constituent parts of the caricature-to-be-created corresponding to the current display direction based on the address(es) where the parts of the caricature are located; and use the found constituent parts as the current constituent parts of the caricature-to-be-created.

In some embodiments, the first combination module is configured to: judge whether the found current constituent parts are stored in a specified storage area; wherein if not, download the current constituent parts in the second server to the specified storage area and combine the current constituent parts in the specified storage area to form a target caricature.

In some embodiments, the first combination module is configured to: acquire part attribute information of each of the current constituent parts, wherein the part attribute information includes part size, part location, and part layer; and combine the current constituent parts based on the part attribute information to form a target caricature.

In some embodiments, the apparatus further comprises:

a new part acquisition module configured to acquire constituent parts corresponding to a new display direction of the caricature-to-be-created based on the identifier and the current display direction of the caricature-to-be-created when a turning instruction is received;

a second combination module configured to combine the acquired constituent parts to form a target caricature in the new display direction; and

a second rendering module configured to render the target caricature in the new display direction.

In some embodiments, the new part acquisition module is configured to: search the first server for all the constituent parts corresponding to the caricature-to-be-created based on the identifier of the caricature-to-be-created; determine a next display direction of the caricature-to-be-created based on the current display direction of the caricature-to-be-created and a predetermined turning order; and search for constituent parts corresponding to the next display direction.

The present disclosure also provides a storage device in which a plurality of instructions are stored, wherein the instructions is adapted to be loaded and executed by a processor to: acquire an identifier of a caricature-to-be-created and a current display direction of the caricature-to-be-created; search for caricature attribute information based on the identifier of the caricature-to-be-created; search for current constituent parts of the caricature-to-be-created based on the caricature attribute information and the current display direction; combine the current constituent parts to form a target caricature; and render the target caricature and use the rendered target caricature as the created caricature.

The present disclosure also provides an electronic device, comprising a processor adapted to implement each instruction; and a storage device adapted to store a plurality of instructions, wherein the instructions are adapted to be loaded and executed by the processor to:

acquire an identifier of a caricature-to-be-created and a current display direction of the caricature-to-be-created; search for caricature attribute information based on the identifier of the caricature-to-be-created; search for current constituent parts of the caricature-to-be-created based on the caricature attribute information and the current display direction: combine the current constituent parts to form a target caricature; and render the target caricature and use the rendered target caricature as the created caricature.

Further, the present disclosure also provides an electronic device comprising a processor and a machine-readable storage medium, wherein machine executable instructions executable by the processor are stored in the machine-readable storage medium, the processor executes the machine executable instructions to implement a caricature creation method provided in the present disclosure.

Referring to a schematic structural diagram of an electronic device shown in FIG. 22, the electronic device comprises: a processor 220, a memory 221, a bus 222, and a communication interface 223, where the processor 220, the communication interface 223, and the memory 221 are connected by the bus 222; and the processor 220 is configured to execute an executable module, such as a computer program, stored in the memory 221.

Here, the memory 221 may include a high-speed random access memory (RAM), or may also include a non-volatile memory, such as at least one disk memory. The communication connection between the system network element and at least one other network element is implemented by at least one communication interface 223 (which may be wired or wireless), and may be implemented by using Internet, a wide area network, a local network, a metropolitan area network, or the like.

The bus 222 may be an ISA bus, a PCI bus, an EISA bus, or the like. The bus may be divided into an address bus, a data bus, a control bus, and the like. For ease of representation, the bus is represented with only one double-headed arrow in FIG. 22, but it does not mean that there is only one bus or one type of bus.

Here, the memory 221 is configured to store a program, the processor 220 executes the program after receiving an execution instruction, and the method executed by the apparatus defined by the flow process disclosed in any one of the foregoing embodiments in the present disclosure may be applied to the processor 220, or implemented by the processor 220.

The processor 220 may be an integrated circuit chip with a signal processing capability. In the implementation process, each of the steps of the abovementioned method may be carried out by an integrated logic circuit of hardware in the processor 220 or by an instruction in a form of software. The abovementioned processor 220 may be a general-purpose processor, including a central processing unit (simply referred to as CPU), a network processor (simply referred to as NP), etc., or may also be a digital signal processor (simply referred to as DSP), an application specific integrated circuit (simply referred to as ASIC), a field-programmable gate array (simply referred to as FPGA) or other programmable logic device, discrete gate or transistor logic device, or discrete hardware component. The methods, steps, and logical block diagrams disclosed in the present disclosure may be implemented or executed. The general-purpose processor may be a microprocessor, or the processor may also be any conventional processor or the like. The steps of the method disclosed in connection with the present disclosure may be directly embodied to be carried out by a hardware decoding processor, or be carried out with a combination of hardware and software modules in the decoding processor. The software module may be located in a storage medium developed in the art such as a random access memory, a flash memory, a read only memory, a programmable read-only memory or an electrically erasable programmable memory, a register, or the like. The storage medium is located in the memory 211, and the processor 220 reads information in the memory 221 and carries out the steps of the abovementioned method in combination with its hardware.

Embodiments of the present disclosure also provide a machine-readable storage medium, the machine-readable storage medium storing machine executable instructions that, when invoked and executed by a processor, cause the processor to implement the above-mentioned caricature creation method according to the embodiment of the present disclosure.

In summary, the method of the present disclosure can be used to quickly, conveniently, and efficiently complete the creation and display of an animation caricature or the selection/replacement and combination of material components of the animation caricature, and can achieve the matching of various components to obtain a more enriched image, and can be used widely, for example, in comics, cartoons, illustrations, graphic exhibition or avatars of network accounts and so on.

It should be understood that the applications of the present disclosure are not limited to the examples given above, and improvements or variations may be made by those skilled in the art according to the above description, and all such improvements and variations should fall within the protection scope of the appended claims of the present disclosure.

### INDUSTRIAL APPLICABILITY

The technical solution of the present disclosure can be applied to quickly, conveniently, and efficiently complete the creation of an animation caricature, and can be used widely, for example, in comics, cartoons, illustrations, graphic exhibition or avatars of network accounts and so on.

1. A caricature creation method, wherein the method is executable by an electronic device, the method comprising:
acquiring an identifier of a caricature-to-be-created and a current display direction of the caricature-to-be-created;
searching for caricature attribute information based on the identifier of the caricature-to-be-created;
searching for current constituent parts of the caricature-to-be-created based on the caricature attribute information and the current display direction;
combining the current constituent parts to form a target caricature; and
rendering the target caricature and using the rendered target caricature as a created caricature.

2. The method according to claim 1, wherein the step of searching for caricature attribute information based on the identifier of the caricature-to-be-created comprises a step of:
searching a first server for caricature attribute information corresponding to the identifier of the caricature-to-be-created, wherein the caricature attribute information includes more than one of an address where the constituent parts of the caricature are located, a name of the caricature, a gender of the caricature and a thumbnail of the caricature.

3. The method according to claim 1, wherein the caricature attribute information comprises an address where the constituent parts of the caricature are located, and the step of searching for the current constituent parts of the caricature-to-be-created based on the caricature attribute information and the current display direction comprises steps of:
searching a second server for constituent parts of the caricature-to-be-created corresponding to the current display direction based on the address where the constituent parts of the caricature are located; and
using found constituent parts as the current constituent parts of the caricature-to-be-created.

4. The method according to claim 3, wherein the step of combining the current constituent parts to form a target caricature comprises steps of:
judging whether the found current constituent parts are stored in a specified storage area, wherein if the found current constituent parts are not stored in the specified storage area, the current constituent parts in the second server are downloaded to the specified storage area; and
combining the current constituent parts in the specified storage area to form the target caricature.

5. The method according to claim 4, wherein the step of combining the current constituent parts in the specified storage area to form the target caricature comprises steps of:
acquiring part attribute information of each of the current constituent parts, wherein the part attribute information includes a part size, a part location, and a part layer; and
combining the current constituent parts based on the part attribute information to form the target caricature.

6. The method according to claim 1, wherein the method further comprises:
acquiring constituent parts corresponding to a new display direction of the caricature-to-be-created based on the identifier and the current display direction of the caricature-to-be-created when a turning instruction is received;
combining the acquired constituent parts to form a target caricature in the new display direction; and
rendering the target caricature in the new display direction.

7. The method according to claim 6, wherein the step of acquiring constituent parts corresponding to a new display direction of the caricature-to-be-created based on the identifier and the current display direction of the caricature-to-be-created comprises steps of:
searching a first server for all the constituent parts corresponding to the caricature-to-be-created based on the identifier of the caricature-to-be-created;
determining a next display direction of the caricature-to-be-created based on the current display direction of the caricature-to-be-created and a predetermined turning order; and
searching for constituent parts corresponding to the next display direction.

8. The method according to claim 1, wherein the constituent parts include a body part, a face shape part, a facial expression part, and a hairstyle part.

9. The method according to claim 1, wherein each of the constituent parts is corresponding to at least one layer preset.

10. A caricature creation apparatus, wherein the apparatus is disposed on an electronic device, the apparatus comprising:
an acquisition module configured to acquire an identifier of a caricature-to-be-created and a current display direction of the caricature-to-be-created;
an attribute searching module configured to search for caricature attribute information based on the identifier of the caricature-to-be-created;
a part searching module configured to searching for current constituent parts of the caricature-to-be-created based on the caricature attribute information and the current display direction;
a first combination module configured to combine the current constituent parts to form a target caricature; and
a first rendering module configured to render the target caricature and use the rendered target caricature as a created caricature.

11. The apparatus according to claim 10, wherein the attribute searching module is configured to:
search a first server caricature attribute information corresponding to the identifier of the caricature-to-be-created, wherein the caricature attribute information includes more than one of an address where the constituent parts of the caricature are located, a name of the caricature, a gender of the caricature and a thumbnail of the caricature.

12. The apparatus according to claim 10, wherein the caricature attribute information includes an address where the constituent parts of the caricature are located, and the part searching module is configured to:
search a second server for constituent parts of the caricature-to-be-created corresponding to the current display direction based on the address where the constituent parts of the caricature are located; and
use found constituent parts as the current constituent parts of the caricature-to-be-created.

13. The apparatus according to claim 12, wherein the first combination module is configured to:
judge whether the found current constituent parts are stored in a specified storage area, wherein if the found current constituent parts are not stored in the specified storage area, the current constituent parts in the second server are downloaded to the specified storage area; and
combine the current constituent parts in the specified storage area to form a target caricature.

14. The apparatus according to claim 13, wherein the first combination module is configured to:
acquire park attribute information of each of the current constituent parts, wherein the part attribute information includes a part size, a part location, and a part layer; and
combine the current constituent parts based on the part attribute information to form a target caricature.

15. The apparatus according to claim 10, wherein the apparatus further comprises:
a new part acquisition module configured to acquire constituent parts corresponding to a new display direction of the caricature-to-be-created based on the identifier and the current display direction of the caricature-to-be-created when a turning instruction is received;
a second combination module configured to combine the acquired constituent parts to form a target caricature in the new display direction; and
a second rendering module configured to render the target caricature in the new display direction.

16. The apparatus according to claim 15, wherein the new part acquisition module is configured to:
search a first server for all the constituent parts corresponding to the caricature-to-be-created based on the identifier of the caricature-to-be-created;
determine a next display direction of the caricature-to-be-created based on the current display direction of the caricature-to-be-created and a predetermined turning order; and
search for constituent parts corresponding to the next display direction.

17. An electronic device, comprising:
a processor adapted to implement each instruction; and
a storage device adapted to store a plurality of instructions, wherein the instructions are adapted to be loaded and executed by the processor to:
acquire an identifier of a caricature-to-be-created and a current display direction of the caricature-to-be-created;
search for caricature attribute information based on the identifier of the caricature-to-be-created;
search for current constituent parts of the caricature-to-be-created based on the caricature attribute information and the current display direction;
combine the current constituent parts to form a target caricature; and
render the target caricature and use the rendered target caricature as a created caricature.
